(19) United States
(12) Patent Application Publication
(10) Pub. No.: US 2011/0083267 A1
(43) Pub. Date: Apr. 14, 2011

(54) Mechanically assisted dependent transfer mechanism

(76) Inventors: Brenton D. Gibson, Corvallis, OR (US); Jonathan J. Mast, Everett, WA (US); Joseph R. Zaworski, Corvallis, OR (US); Katharine M. Hunter-Zaworski, Corvallis, OR (US)

(21) Appl. No.: 12/924,372

(22) Filed: Sep. 24, 2010

Related U.S. Application Data
(60) Provisional application No. 61/277,498, filed on Sep. 24, 2009.

(51) Int. Cl. A61G 7/14

(52) U.S. Cl. 5/87.1

(57) ABSTRACT

An assistive transfer mechanism is provided allowing for effective and comfortable transfers from one sitting position to another sitting position. The assistive transfer mechanism includes a horizontal base with a vertical (height adjustable) column disposed on the horizontal base. At least one articulating arm extends from the vertical column which holds a torso engaging element. The torso engaging element includes a weight support mechanism to support at least part of a subject's body weight. The torso engagement element is capable of transferring and applying only a fraction of the supported body weight into a lateral to medial directed force onto the subject's torso.

### CROSS-REFERENCE TO RELATED APPLICATIONS

This application claims priority from U.S. Provisional Patent Application 61/277,498 filed Sep. 24, 2009, which is incorporated herein by reference.

### FIELD OF THE INVENTION

The present invention relates generally to adaptive equipment. More particularly, the invention relates to adaptive equipment that facilitates transferring mobility impaired individuals without requiring strenuous effort by the subject or assistant.

### BACKGROUND OF THE INVENTION

Travelers who are disabled and wheelchair bound have to undergo a transfer process to for example board and deplane a commercial aircraft. The transfer process is typically done manually with a flight attendant physically lifting the disabled passenger. This manual process exposes risk of injury to the passenger and attendants. By developing a mechanical device to aid in the transfer process, those risks could be minimized while simultaneously providing a better experience for those involved. Other individuals have investigated and quantified various aspects of this challenge, but there is still a desire to advance the art with better solutions. The present invention describes aspects of the transfer of a passenger from their personal wheelchair to their assigned aircraft seat during boarding and deplaning. In general, the present invention addresses aspect of a transfer from one sitting position to another sitting position.

### SUMMARY OF THE INVENTION

An assistive transfer mechanism is provided allowing for effective and comfortable transfers from one sitting position to another sitting position. The assistive transfer mechanism includes a horizontal base with a vertical (height adjustable) column disposed on the horizontal base. At least one articulating arm extends from the vertical column which holds a torso engaging element. The torso engaging element includes a weight support mechanism to support at least part of a subject's body weight. The torso engagement element is capable of transferring and applying only a fraction of the supported body weight into a lateral to medial directed force onto the subject's torso. In one example, the transferred and applied force is in a range of 30% to 60% of the subject's body weight. In another example, the transferred and applied force is in a range of 42% to 50% of the subject's body weight. The torso engaging element has two pivoted joints each affixed within the torso engaging element under an angle with vertical. It is these angles of the pivoted joints enabling the effective and comfortable transfer force to the subject. In one example, the affixed angle is in the range of 31 to 50 degrees. In another example, the affixed angle is in the range of 40 to 44 degrees.

### BRIEF DESCRIPTION OF THE DRAWINGS

FIG. 1 shows an example of a mechanically assisted dependent transfer mechanism according to an exemplary embodiment of the invention.

FIGS. 2-4 show examples of the torso engaging element according to an exemplary embodiment of the invention.

### DETAILED DESCRIPTION

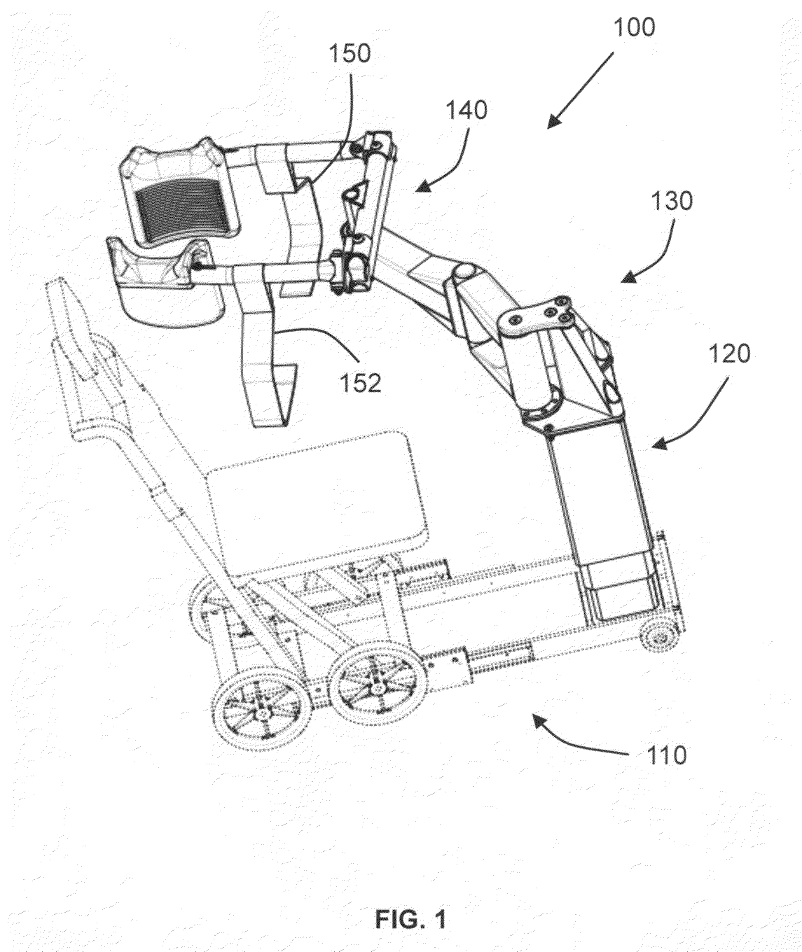

An assistive transfer mechanism 100 is provided for use of transferring a person from a wheelchair to another seating arrangement such as an airplane seat (FIG. 1). Assistive transfer mechanism 100 includes a horizontal transfer base 110, a vertical lift (adjustable) column 120 disposed on base 110, at least one articulating arm 130 extending horizontally from vertical column 120, and a torso engaging element 140, which is also referred to as a subject interface.

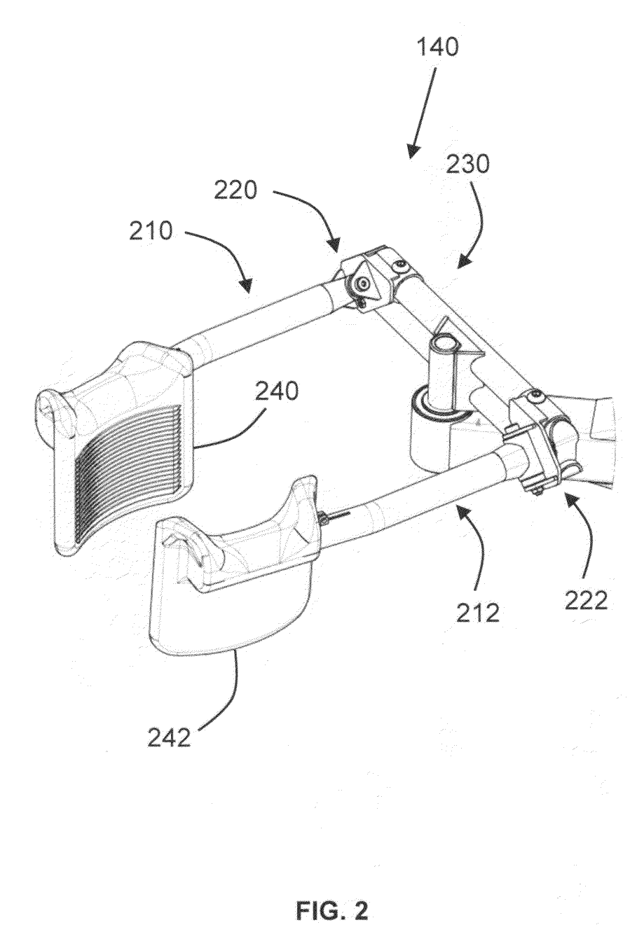

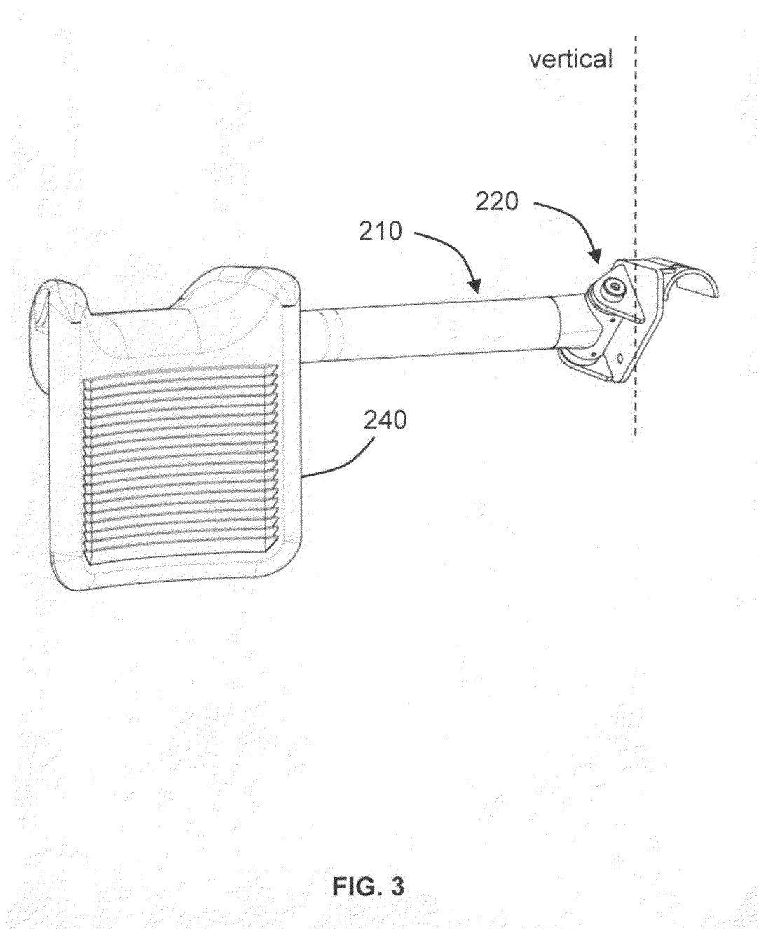

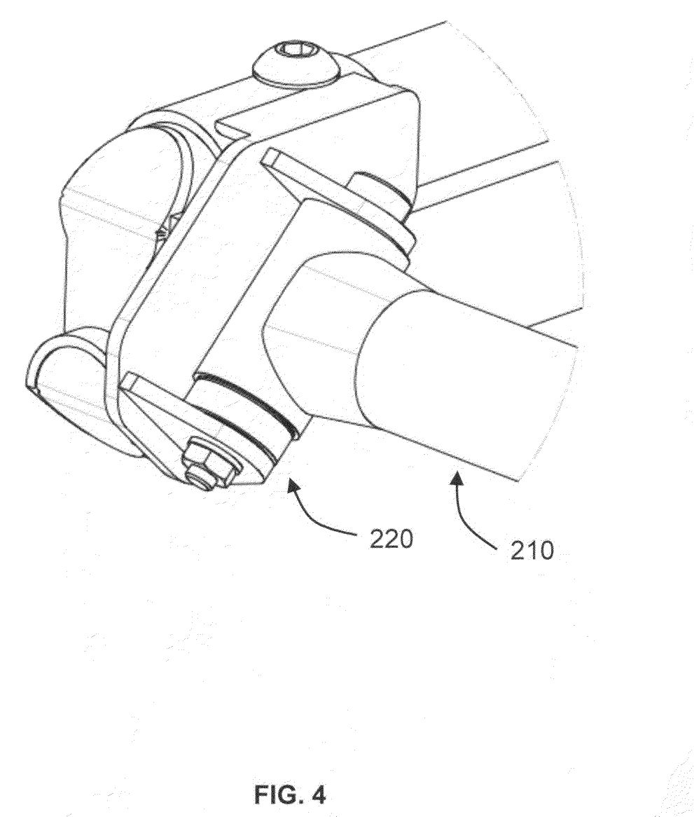

As shown in FIGS. 2-3, subject interface 140 includes two arms 210, 212 connected by a pivot joint 220, 222 which is affixed to connecting arm 230. An important aspect is that each pivot joint 220, 222 is affixed or bracketed to connecting arm 230 under an angle relative to vertical. The pivot joint is affixed such that arms 210, 212 and therewith paddles 240, 242 are capable of rotating downwards and towards the subject as shown in FIGS. 2-4. Paddles 240, 242 are attached at the ends of the arms 210, 212 and capable of applying force to the subject's torso.

A key aspect of one embodiment pertains to the way that lateral-to-medial force is applied to a subject's torso by each of the paddles. For this applied force to be effective for transfer purposes and comfortable to the subject, it needs to be about 42% to 50% of the body weight of the subject. In another embodiment, the applied force could be in the range of 30% to 60% of the body weight of the subject. The 30% to 60% of body weight is the horizontal force each of the paddles are exerting. In this example, the weight being lifted by each arm (which includes both the vertical force resulting from friction between the paddle and the torso and the vertical force from the leg straps) is about 50% of the body weight.

To enable the weight transfer in the desired amount, a weight support mechanism in the form of e.g. straps or leg supports 150, 152 are attached to each of the arms of the subject interface 140 to support the weight of the subject's legs. The weight applied to these straps causes a downward force on each of arms 210, 212 of subject interface 140. However, the angled and pivoted joint of the two arms of the subject interface causes each arm 210, 212 to also move horizontally (i.e. towards each other in perspective of FIGS. 1-2) and therewith impose the desired lateral-to-medial force on the subject's torso. The use of the pivoted joint and the angle or angular ranged at which it is affixed to connecting arm 230 of the subject interface also causes the applied force to be in a range desired range. In one embodiment, the angle of the bracket of the pivot joint is optimally about 42 degrees, but preferably 40 to 44 degrees relative to vertical. In another embodiment, the angle is 31 to 50 degrees relative to vertical. This corresponds to a horizontal force applied to the torso of 30 to 60% of body weight. It is noted that at angles less than 31 degrees the paddles slip on the torso during lifting.

The invention has now been described with examples which are meant to be illustrative and should not be regarded as limiting to the scope of the invention as claimed. For example, despite the fact that some parts of the description focuses on airplane transfers, the invention is not limited to airplane transfers. In fact, it is also useful to other applications including any situation in which a person must be transferred to or from a sitting position in one place to a sitting position in another. Some examples are where a person is transferred from a hospital bed (with a raised head) to a wheelchair, to or from a wheelchair to a toilet or a bath. In general, other examples pertain to getting in and out of a seat (airplane, car, or any seat).

What is claimed is:

1. An assistive transfer mechanism, comprising:
a) a horizontal base;
b) a vertical column disposed on said horizontal base;
c) at least one articulating arm extending from said vertical column; and
d) a torso engaging element comprising a weight support mechanism to support at least part of a subject's body weight, wherein said torso engagement element is capable of transferring and applying said supported body weight into a lateral to medial directed force onto the subject's torso, and wherein said transferred and applied force is in a range of 30% to 60% of said subject's body weight.

2. The assistive transfer mechanism as set forth in claim 1, wherein said torso engaging element comprises two pivoted joints each affixed within said torso engaging element under an angle with vertical.

3. The assistive transfer mechanism as set forth in claim 2, wherein said affixed angle is in the range of 40 to 44 degrees.

4. The assistive transfer mechanism as set forth in claim 2, wherein said affixed angle is in the range of 31 to 50 degrees.

5. The assistive transfer mechanism as set forth in claim 2, wherein said affixed angle is about 42 degrees.

6. The assistive transfer mechanism as set forth in claim 1, wherein said transferred and applied lateral to medial force is in a range of 42% to 50% of said subject's body weight.

7. The assistive transfer mechanism as set forth in claim 1, wherein said torso engaging element comprises two paddles used for the lateral to medial force application onto the subject's torso.

8. The assistive transfer mechanism as set forth in claim 1, wherein said vertical column can be adjusted in height.
